(19) United States
(12) Patent Application Publication
(10) Pub. No.: US 2003/0145284 A1
(43) Pub. Date: Jul. 31, 2003

(54) Enforcing an upper bound on the display height of mathematical expressions on a handheld electronic device

(76) Inventors: Todd D. Fortenberry, McKinney, TX (US); Malgorzata A. Brothers, Plano, TX (US)

Correspondence Address: TEXAS INSTRUMENTS INCORPORATED, P O BOX 655474, M/S 3999, DALLAS, TX, 75265

(21) Appl. No.: 10/060,028

(22) Filed: Jan. 28, 2002

(51) Int. Cl. G06F 15/00

(52) U.S. Cl. 715/517

(57) ABSTRACT

A method and handheld computing device wherein an upper bound is enforced on the display height of mathematical expressions (234) on a display screen (211) of a handheld computing or electronic device. At least one transformation (230) remains visible on the display screen (211), and portions of the object (234) exceeding the upper bound are truncated. An arrow (236) may be used to indicate the presence of truncated portions of the object (234), and to indicate that the object (234) may be scrolled either vertically or horizontally for viewing of the entire object (234).

### CROSS-REFERENCE TO RELATED APPLICATIONS

Embodiments of the present invention are related to commonly-assigned U.S. patent application, Ser. No. 09/938,772, filed on Aug. 24, 2001 by Brothers, et al., entitled “Selection Of Mathematical Objects From The History Screen On A Handheld Device,” which is incorporated herein by reference.

### BACKGROUND

Electronic calculators have become a common tool for teaching students mathematics. In particular, graphing calculators are being utilized in the classroom. Graphing calculators are characterized by a larger screen, which permits the entry of mathematical objects in a logical format. The term “object” is used herein to refer to a mathematical expression.

Graphing calculators also permit graph displays and table displays. They have more sophisticated programming capability than other calculators, and often permit data transmission to other computing devices, directly or via a data storage medium, as well as data collection via various interface protocols. Particular calculator models are often designed for particular educational levels. For example, a calculator for middle school students might have less advanced features than one designed for older students. However, regardless of the level for which a calculator is designed, a continual goal in designing them is to provide a logical and easy-to-use user interface.

Modem calculators have increased functionality compared with calculators of the past. Some calculators are educational calculators designed for use by students, and some of these educational calculators contain finctionalities designed to facilitate students' learning and understanding of mathematical expressions. Some calculators may utilize a step-by-step Computer Algebra System (CAS) that allows users to transform mathematical expressions much in the same way they would with a pencil and paper.

Some prior graphing calculators allow the user to view a history screen, which is a scrolling display of previous display outputs. See U.S. patent application Ser. No. 09/938,772, filed on Aug. 24, 2001 by Brothers, et al., entitled “Selection Of Mathematical Objects From The History Screen On A Handheld Device,” which is incorporated herein by reference.

While graphing calculators typically include a display screen that is larger than the displays of traditional handheld calculators, graphing calculator display screens are capable of displaying less information than can be displayed by a desk or lap-top computer. For example, a graphing calculator screen may be capable of displaying 160×100 pixels, for example, whereas a desk-top computer screen is typically capable of displaying 640×480 pixels to 1280×1024 pixels.

If any single mathematical expression occupies the entire visible history screen on the handheld calculator display screen, then it becomes difficult for students to keep track of the problem, to understand the solution steps and to view enough of the derivation on the display screen to decide what to do next. This is particularly problematic in simplifying expressions, solving equations, and computing derivatives, for example.

### SUMMARY OF THE INVENTION

Embodiments of the present invention provide technical advantages as a handheld computing device and method wherein an upper bound is enforced on the display height of objects or mathematical expressions on the display screen. A user of the handheld device is able to view at least one of the transformations performed on the objects either above or below any given object. The user may scroll through any of the objects vertically or horizontally in order to view the entire object, while at least one transformation remains in view on the screen.

In one embodiment, disclosed is a method of displaying a sequence of steps in a mathematical derivation on a display screen of a handheld computing device. The sequence of steps comprises a plurality of objects and a plurality of transformations. The method comprises displaying at least one transformation on the display screen. The method also comprises displaying at least a portion of at least one object on the display screen, wherein an upper bound is enforced on the display height of the object.

Also disclosed is a handheld computing device comprising a display screen capable of displaying mathematical expressions, the display screen including a cursor. The device includes a key panel having keys at least capable of selecting positions of the cursor and moving the cursor horizontally or vertically on the display screen. The device includes a memory for storing at least an algorithm, and a processor for executing the algorithm. The algorithm comprises a method of displaying a sequence of steps in manipulating mathematical expressions on the display screen. The sequence of steps comprises a plurality of objects and a plurality of transformations. The method comprises displaying at least one transformation on the display screen and includes displaying at least a portion of at least one object on the display screen, wherein an upper bound is enforced on the display height of the object.

The user may more easily follow a mathematical derivation by being able to view as much of the derivation on the display screen at any given instance as is reasonably possible. Advantages of embodiments of the present invention include ensuring that a handheld device user is able to view at least one transformation either above or below any given object on the display screen.

### BRIEF DESCRIPTION OF THE DRAWINGS

The above features of embodiments of the present invention will be more clearly understood from consideration of the following descriptions in connection with accompanying drawings in which:

FIG. 1 illustrates a prior art history screen with a plurality of transformations and objects in view;

FIG. 2 illustrates a display screen in accordance with an embodiment of the present invention wherein an object exceeding the upper bound of the display height is truncated vertically;

FIG. 3 illustrates the display screen of FIG. 2 after scrolling through the object in order to view the entire object;

FIG. 4 illustrates an embodiment of the present invention wherein an object is truncated horizontally, wherein the object may be scrolled horizontally to view the entire object; and

FIG. 5 illustrates a front panel of a handheld calculator in accordance with embodiments of the invention.

Corresponding numerals and symbols in the different figures refer to corresponding parts unless otherwise indicated. The figures are drawn to clearly illustrate the relevant aspects of the preferred embodiments and are not necessarily drawn to scale.

### DETAILED DESCRIPTION OF PREFERRED EMBODIMENTS

Prior art handheld calculators will be discussed, followed by a description of some preferred embodiments of the invention and some advantages thereof.

The display of successive steps of a mathematical derivation on an electronic device is usually done in a vertical fashion, listing one step after the other, as is customarily done when using pencil and paper. It is possible that a single step in a mathematical derivation can generate a mathematical expression that is too tall to fit on the screen of an electronic device. This possibility is even greater when the electronic device is a handheld calculator, which typically has a relatively small display screen. When this happens, the mathematical expression will occupy the entire screen so that a user cannot view any part of the mathematical derivation before or after the expression. This is particularly undesirable when trying to follow the steps of a mathematical derivation.

Embodiments of the present invention overcome this problem by placing an upper bound on the amount of vertical space any given mathematical expression in the derivation can occupy. In doing so, the user is guaranteed to be able to view a portion of the derivation either above or below any given mathematical expression. In addition, embodiments of the invention provide the ability to scroll, independent of scrolling the entire display screen, any of the mathematical expressions vertically or horizontally so that the user can view the entire mathematical expression.

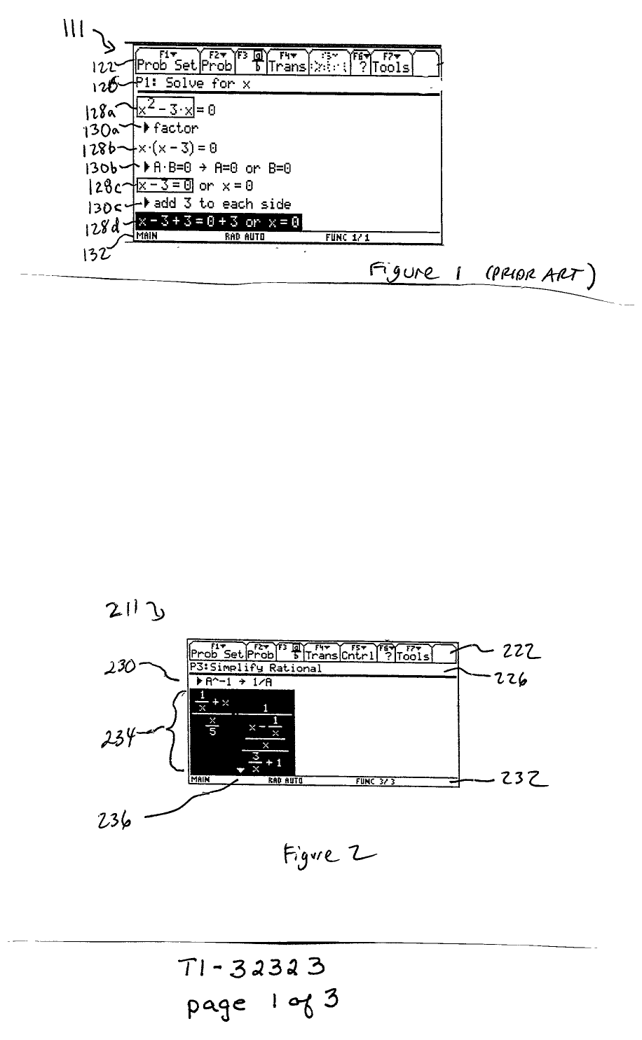

FIG. 1 illustrates a display screen 111 of a prior art handheld calculator, with a history screen visible. The display screen 111 includes a menu bar 122 for selecting various functions of the handheld calculator, and a problem statement line 126, which indicates the problem being solved. The display screen 111 also includes a plurality of objects 128a/128b/128c/128d that are separated by a plurality of transformations 130a/130b/130c. The term “transformation” is used herein to refer to a mathematical manipulation or function that may be performed on an object. The display screen 111 includes a status line 132 located at the bottom for indicating the status of various features of the handheld device.

A problem with the prior art history screen shown on the display screen 111 of FIG. 1 is that if one of the objects 128a/128b/128c/128d is very large, for example, exceeding the size of the entire display screen 111, then the object 128 will occupy the entire screen 111 so that a user cannot view any part of transformations 130a/130b/130c either above or below the object 128a/128b/128c/128d. This makes it difficult for a user of the handheld device to understand and follow the mathematical derivation being attempted.

Embodiments of the present invention achieve technical advantages by placing an upper bound on the display height of objects so that at least one transformation remains in view, while oversized objects are partially truncated from the display screen. The truncated portions of the objects may be indicated by an arrow, and the object may be scrolled, independent of scrolling the entire display screen, for viewing by the user either vertically or horizontally.

FIG. 2 illustrates a display screen 211 in accordance with an embodiment of the present invention. The display screen 211 may comprise a menu bar 222 and a problem statement line 226 disposed in a top region of the display screen 211, for example. The display screen 211 may also comprise a status line 232, located near the bottom portion of the display screen 211, for example. The display screen 211 may also include an optional title line, not shown in FIG. 2, disposed between the menu bar 222 and problem statement line 226, for example. The menu bar 222, title line, problem statement line 226, and status line 232 may be positioned in a variety of locations on the display screen 211, for example.

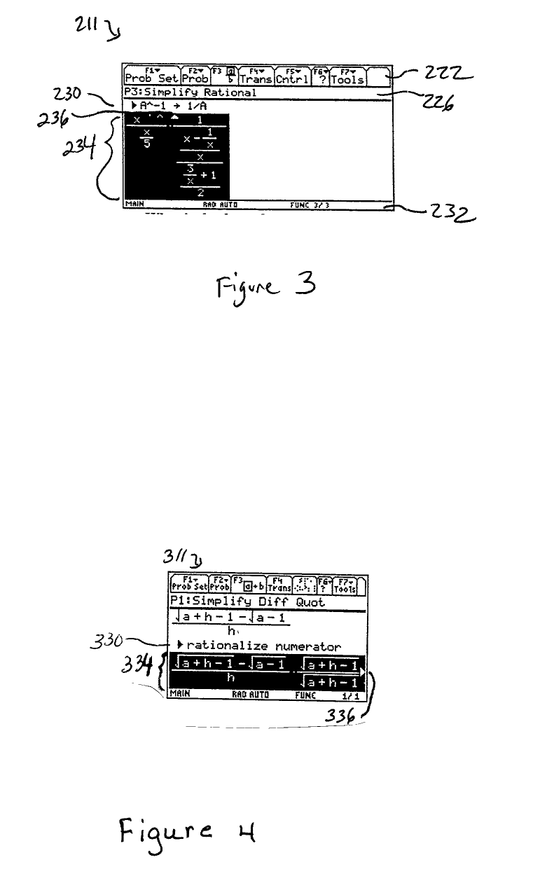

In accordance with embodiments of the present invention, the display screen 211 includes at least one transformation 230, and includes a portion of object 234 that has been truncated in order to allow the transformation 230 to remain in view. An arrow 236 below the object 234 indicates that a portion of the object 234 has been truncated vertically and that the object 234 may be scrolled downwards for a complete viewing of the object 234. FIG. 3 shows the display screen 211 after the object 234 has been scrolled to view the remaining truncated portion of the object 234, with arrow 236 above the object 234 indicating that the object 234 may be scrolled upwards to view upper portions of the object 234.

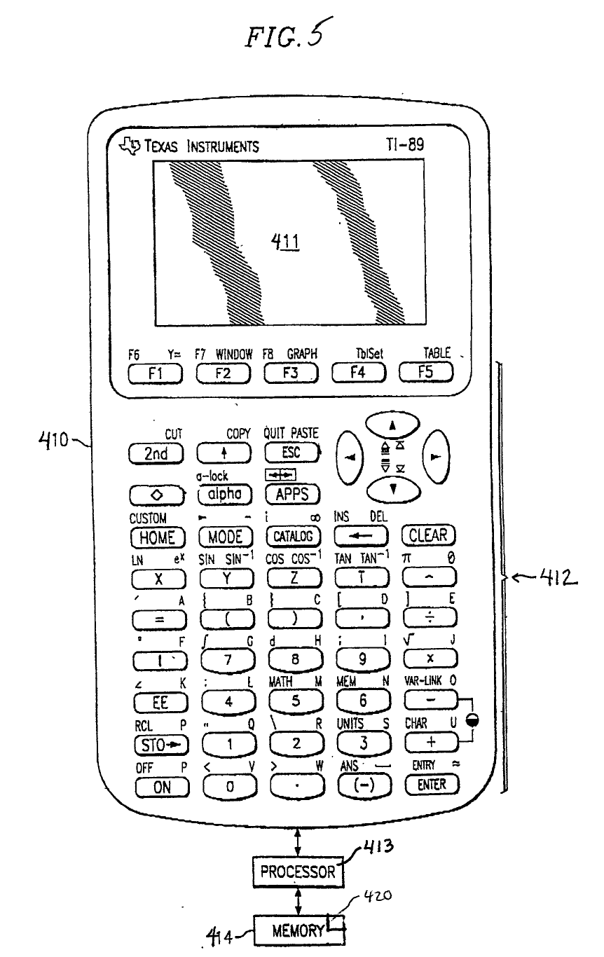

FIG. 4 illustrates a display screen 311 having an object 334 that has been truncated horizontally, e.g., on the right hand side of the display screen 311. Arrow 336 indicates that the object 334 has been truncated and indicates that the object 334 may be scrolled horizontally in order to view the entire object 334.

Embodiments of the present invention include a method or algorithm for displaying a sequence of steps in a mathematical derivation on a display screen 211/311 of a handheld computing device, wherein at least one transformation 230 is displayed on the display screen 211/311 and at least a portion of at least one object 234 is displayed simultaneously on the display screen, wherein an upper bound is enforced on the display height of the object.

In one embodiment, the arrow 236/336 points toward the truncated portions of the object 234/334. The user can scroll the object 234/334 in order to view the entire object 234/334. The upper bound may comprise around 110×60 pixels for a 160×100 pixel handheld calculator display screen, as an example. The upper bound may be horizontal, vertical, or both, for example. The object 234/334 preferably comprises a mathematical expression, and the mathematical derivation may include simplifying expressions, solving equations, and/or computing derivatives, as examples. For example, the mathematical derivation may include simplifying expressions such as powers, polynomial expressions, rational expressions, radical expressions, logarithmic and exponential expressions, and difference quotients, as examples. The mathematical derivations may also include, as examples, solving linear equations, quadratic equations, rational equations, radical equations, and/or logarithmic and exponential equations. Embodiments of the present invention are particularly advantageous in computing complex derivatives, for example.

Embodiments of the present invention also include a handheld computing device 410, shown in FIG. 5, having a display screen 411, a key panel 412, a memory 414 for storing an algorithm 420, and a processor 413 for executing the algorithm 420. The algorithm 420 comprises a method of displaying a sequence of steps in manipulating mathematical equations on the display screen, the sequence of steps comprising a plurality of objects 234/334 and a plurality of transformations 230/330, wherein the method comprises displaying at least one transformation 230/330 on the display screen 211/311, and displaying at least a portion of at least one object 234/334, wherein an upper bound is enforced on the display of the object 234/334. The object 234/334 may comprise constants, variables, functions, algebraic expressions, or combinations thereof.

FIG. 5 illustrates a front panel of a calculator 410 that is adapted to incorporate features of embodiments of the present invention. Calculator 410 is described and shown herein in terms of particular software and hardware features of the TI-89, a commercially available graphing calculator manufactured by Texas Instruments Incorporated. Apart from the features of the present invention, many of the features of calculator 410 described herein are typical of graphing calculators, while other features are unique to the TI-89 and TI92 Plus “family” of TI calculators. The use of the TI-89 is for purposes of description, and does not limit embodiments of the invention. The features that are the subject of embodiments of the present invention may be incorporated into other calculators that provide graphical displays, or they may be incorporated into other computer-based teaching tools and handheld computers, as examples.

In FIG. 5, the screen 411 of calculator 410 includes a “graphical display”, as that term is used herein. In addition to the ability to draw graphical displays of various types, some of the software features of calculator 410 include software applications, loading, storage, and keystroke programming. The calculator 410 also permits data collection, display and analysis.

Various hardware features include a large pixel screen 411, which may be 100×160 pixels, for example. A keypad 412 has various keys for data and command entry, some of which are used to implement the invention and are described herein. The calculator includes a processor 413 connected to a memory unit 414 which may comprise a 256 Kbyte RAM and 721 Kbyte application space, as examples. The algorithm 420 described herein is adapted to reside in the memory unit 414 of the calculator 410. The calculator may also include an I/O port for data linking, and a unit-to-unit link cable connection capability, not shown. As is typical of calculators, the calculator 410 may include a secondary function key, the “2nd” key, which permits other keys to have two functions. For example, by pressing “2nd” key and then the “ESC/QUIT” key, the calculator performs the QUIT function. The calculator 410 may also include an “alpha”, which when depressed makes the other keys subsequently depressed to input an alpha character.

Advantages of embodiments of the present invention include insuring that a user is able to view a portion of a mathematical derivation either above or below any given mathematical expression. The user may more easily follow the mathematical derivation by being able to view the entire object or mathematical expression 234/334, which is particularly advantageous in the complex mathematical derivations. It is also beneficial to be able to view at least one transformation 230/330 simultaneously while viewing at least a portion of an object 234/334.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description. In addition, the order of process steps may be rearranged by one of ordinary skill in the art, yet still be within the scope of the present invention. It is therefore intended that the appended claims encompass any such modifications or embodiments. Moreover, the scope of embodiments of the present application is not intended to be limited to the particular embodiments of the process, machine, manufacture, composition of matter, means, methods and steps described in the specification. Accordingly, the appended claims are intended to include within their scope such processes, machines, manufacture, compositions of matter, means, methods, or steps.

What is claimed is:

1. A method of displaying a sequence of steps in a mathematical derivation on a display screen of a handheld computing device, the sequence of steps comprising a plurality of objects and a plurality of transformations, wherein the method comprises:
displaying at least one transformation on the display screen; and
displaying at least a portion of at least one object on the display screen, wherein an upper bound is enforced on the display height of the object.

2. The method according to claim 1, wherein an object subjected to the upper bound is partially truncated from view on the display screen, further comprising:
displaying an arrow to indicate the object truncated portions, wherein a user of the handheld computer device can select the arrow to view the object truncated portions.

3. The method according to claim 2, wherein the arrow points towards the truncated portions of the object.

4. The method according to claim 2, wherein the user can scroll the object, independent of scrolling the entire display screen, to view the entire object.

5. The method according to claim 1, wherein the upper bound comprises around 110×60 pixels for a 160×100 pixel handheld calculator display screen.

6. The method according to claim 1, wherein the upper bound is horizontal or vertical.

7. The method according to claim 6, wherein an object subjected to the upper bound is partially truncated from view on the display screen, further comprising:
displaying an arrow to indicate the object truncated portions, wherein a user of the handheld computer device can select the arrow to view the object truncated portions.

8. The method according to claim 7, wherein the user can scroll the object vertically or horizontally to view the entire object.

9. The method according to claim 1, wherein the object is a mathematical expression.

10. The method according to claim 9, wherein manipulating the mathematical expression comprises a mathematical derivation.

11. The method according to claim 1, further comprising displaying a menu bar, displaying a problem statement line, and displaying a status line on the display screen.

12. A handheld computing device comprising:
a display screen capable of displaying mathematical expressions, the display screen including a cursor;
a key panel having keys at least capable of selecting positions of the cursor and moving the cursor horizontally or vertically on the display screen;
a memory for storing at least an algorithm; and
a processor for executing the algorithm, wherein the algorithm comprises a method of displaying a sequence of steps in manipulating mathematical equations on the display screen, the sequence of steps comprising a plurality of objects and a plurality of transformations, wherein the method comprises displaying at least one transformation on the display screen, and displaying at least a portion of at least one object on the display screen, wherein an upper bound is enforced on the display height of the object.

13. The handheld computing device according to claim 12, wherein an object subjected to the upper bound is partially truncated from view on the display screen, wherein the algorithm further comprises displaying an arrow to indicate the object truncated portions, wherein a user of the handheld computer device can select the arrow to view the object truncated portions.

14. The handheld computing device according to claim 12, wherein the arrow points towards the truncated portions of the object.

15. The handheld computing device according to claim 12, wherein the object may be scrolled, independent of scrolling the entire display screen, so that a user can view the entire object.

16. The handheld computing device according to claim 15, wherein the upper bound is horizontal or vertical, wherein the user can scroll the object vertically or horizontally to view the entire object.

17. The handheld computing device according to claim 12, wherein the display screen comprises a 160×100 pixel handheld calculator display screen, wherein the upper bound comprises around 110×60 pixels.

18. The handheld computing device according to claim 12, wherein the object is a mathematical expression.

19. The handheld computing device according to claim 18, wherein manipulating the mathematical expression comprises a mathematical derivation.

20. The handheld device according to claim 12, wherein the object comprises constants, variables, functions, algebraic expressions, or combinations thereof.

21. The handheld device according to claim 12, wherein manipulating the mathematical expression comprises simplifying expressions and/or solving equations.

22. The handheld device according to claim 12, further comprising a menu bar, a problem statement line, and a status line displayed on the display screen.
